(19) United States
(12) Patent Application Publication
(10) Pub. No.: US 2005/0022850 A1
(43) Pub. Date: Feb. 3, 2005

(54) Regulation of flow of processing chemistry only into a processing chamber

(75) Inventor: William Dale Jones, Phoenix, AZ (US)

Correspondence Address: HAVERSTOCK & OWENS LLP, 162 NORTH WOLFE ROAD, SUNNYVALE, CA, 94086, US

(73) Assignee: Supercritical Systems, Inc.

(21) Appl. No.: 10/630,640

(22) Filed: Jul. 29, 2003

(51) Int. Cl. B08B 3/02

(52) U.S. Cl. 134/58 R; 134/56 R; 134/113; 134/94.1; 134/100.1; 134/102.2; 134/902

(57) ABSTRACT

A method and apparatus for supercritical processing of an object with a fluid. The apparatus comprises means for injecting a processing fluid and chemistry into the system, including means for starting and means for stopping the means for injecting, and means for substantially preventing fluid from re-entering the means for injecting. The method includes the steps of selectively injecting a processing fluid and chemistry. Also, the method includes substantially preventing fluid from returning to the source.

### FIELD OF THE INVENTION

The present invention in general relates to the field of semiconductor wafer cleaning. More particularly, the present invention relates to the regulation of flow of chemistry only into a processing chamber.

### BACKGROUND OF THE INVENTION

It is well known in the industry that particulate surface contamination of semiconductor wafers typically degrades device performance and affects yield. When processing wafers, it is desirable that particles and contaminants such as but not limited to photoresist, photoresist residue, and residual etching reactants and byproducts be minimized.

Supercritical fluids have been suggested for the cleaning of semiconductor wafers (e.g., an approach to using supercritical carbon dioxide to remove exposed organic photoresist film is disclosed in U.S. Pat. No. 4,944,837 to Nishikawa, et al., entitled “Method of Processing an Article in a Supercritical Atmosphere,” issued Jul. 31, 1990). A fluid enters the supercritical state when it is subjected to a combination of pressure and temperature at which the density of the fluid approaches that of a liquid. Supercritical fluids exhibit properties of both a liquid and a gas. For example, supercritical fluids are characterized by solvating and solubilizing properties that are typically associated with compositions in the liquid state. Supercritical fluids also have a low viscosity that is characteristic of compositions in the gaseous state.

A problem in semiconductor device manufacturing is the metering of flow of processing chemistry into a system for supercritical processing of semiconductor wafers. In conventional systems for delivering a fluid through a inlet port into a processing chamber, the accuracy of the fluid delivery can vary as a function of the relative pressure across the inlet port. A potentially serious quality control problem arises when the volumes of successive injections cannot be accurately determined. Such a problem can occur when it is possible for fluid to re-enter the means for injecting. It would be-desirable to have an apparatus for precise fluid regulation under different pressures and flow requirements. It would be advantageous to eliminate the undesired reversal of flow of processing chemistries during injection into a processing chamber.

What is needed is an effective method of regulating a flow of a processing chemistry into a system for supercritical processing of an object with a fluid.

### SUMMARY OF THE INVENTION

A first embodiment of the invention is for an apparatus for use in a system for supercritical processing of an object with a fluid, comprising: means for injecting a processing chemistry into the system, including means for starting and means for stopping the means for injecting; and means for substantially preventing fluid from re-entering the means for injecting.

A second embodiment of the invention is for a system for supercritical processing of an object with a fluid, comprising: a high-pressure process chamber; means for injecting a processing chemistry into the high-pressure process chamber including means for starting and means for stopping the means for injecting; and means for substantially preventing fluid from re-entering the means for injecting.

A third embodiment of the invention is for a supercritical processing system for processing a semiconductor wafer with a fluid, the fluid being from a fluid source, the system comprising: a circulation loop coupled to a high-pressure processing chamber; and an inlet line for introducing the fluid into the circulation loop, the inlet line including: an inlet port in the circulation loop; a back-pressure regulator coupled to the inlet port; a pump for compressing the fluid to form a pressurized fluid; a first line for transferring the pressurized fluid from the pump to the back-pressure regulator, the first line configured to maintain a uni-directional flow of the pressurized fluid from the pump towards the back-pressure regulator; and a second line for transferring a quantity of the fluid from the fluid source to the pump, the second line configured to maintain a uni-directional flow of the fluid from the fluid source to the pump.

A fourth embodiment of the invention is for a method of regulating a flow of a processing chemistry into a system for supercritical processing of an object with a fluid, comprising the steps of: supplying the processing chemistry to a pump for compressing the processing chemistry to form a pressurized fluid; providing a start-stop system for controlling an inlet line for introducing the processing chemistry into the system, such that when a start mode is active the pressurized fluid is introduced into the system, and such that when a stop mode is active the pressurized fluid is not introduced into the system; maintaining a flow of the pressurized fluid when the start mode is active; and preventing a fluid within the system from entering the inlet line while at least one of the start mode and the stop mode is active.

### BRIEF DESCRIPTION OF THE DRAWINGS

The present invention may be better understood by reference to the detailed description and claims when considered in connection with the accompanying drawings, of which:

FIG. 1A is a schematic illustration of an apparatus for use in a system for supercritical processing of an object with a fluid, in accordance with embodiments of the present invention.

FIG. 1B is a schematic illustration of an alternative embodiment of the apparatus for use in a system for supercritical processing of an object with a fluid shown in FIG. 1A.

FIG. 2 is a schematic illustration of a system for supercritical processing of an object with a fluid, in accordance with embodiments of the present invention.

FIG. 3 is a schematic illustration of a supercritical processing system for processing a semiconductor wafer with a fluid, in accordance with embodiments of the present invention.

FIG. 4 is a schematic illustration of a system for supercritical processing of an object with a fluid, in accordance with embodiments of the present invention.

FIG. 5 is a flow chart showing a method of regulating a flow of a processing chemistry into a system for supercritical processing of an object with a fluid, in accordance with embodiments of the present invention.

### DETAILED DESCRIPTION OF THE PREFERRED EMBODIMENTS

The following detailed description with reference to the accompanying drawings is illustrative of various embodiments of the invention. The present invention should not be construed as limited to the embodiments set forth herein. Therefore, the following detailed description is not to be taken in a limiting sense, and the scope of the present invention is defined by the accompanying claims.

The present invention is directed to an apparatus for and method of regulating a flow of a processing chemistry into a system for supercritical processing of an object with a fluid. For the purposes of the invention, “fluid” means a gaseous, liquid, supercritical and/or near-supercritical fluid. In certain embodiments of the invention, “fluid” means gaseous, liquid, supercritical and/or near-supercritical carbon dioxide. It should be appreciated that solvents, co-solvents, chemistries, and/or surfactants can be contained in the carbon dioxide. For purposes of the invention, “carbon dioxide” should be understood to refer to carbon dioxide (CO₂) employed as a fluid in a liquid, gaseous or supercritical (including near-supercritical) state. “Supercritical carbon dioxide” refers herein to CO₂ at conditions above the critical temperature (30.5° C.) and critical pressure (7.38 MPa). When CO₂ is subjected to pressures and temperatures above 7.38 MPa and 30.5° C., respectively, it is determined to be in the supercritical state. “Near-supercritical carbon dioxide” refers to CO₂within about 85% of absolute critical temperature and critical pressure. For the purposes of the invention, “object” typically refers to semiconductor wafers for forming integrated circuits, substrates and other media requiring low contamination levels. As used herein, “substrate” includes a wide variety of structures such as semiconductor device structures typically with a deposited photoresist or residue. A substrate can be a single layer of material, such as a silicon wafer, or can include any number of layers. A substrate can comprise various materials, including metals, ceramics, glass, or compositions thereof.

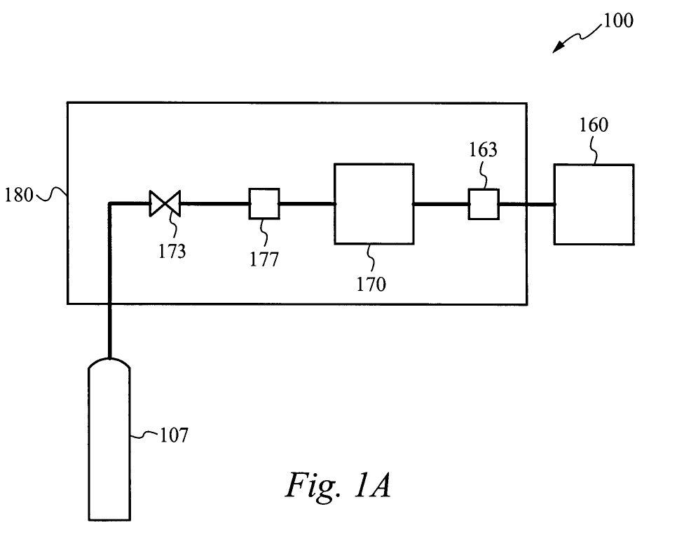

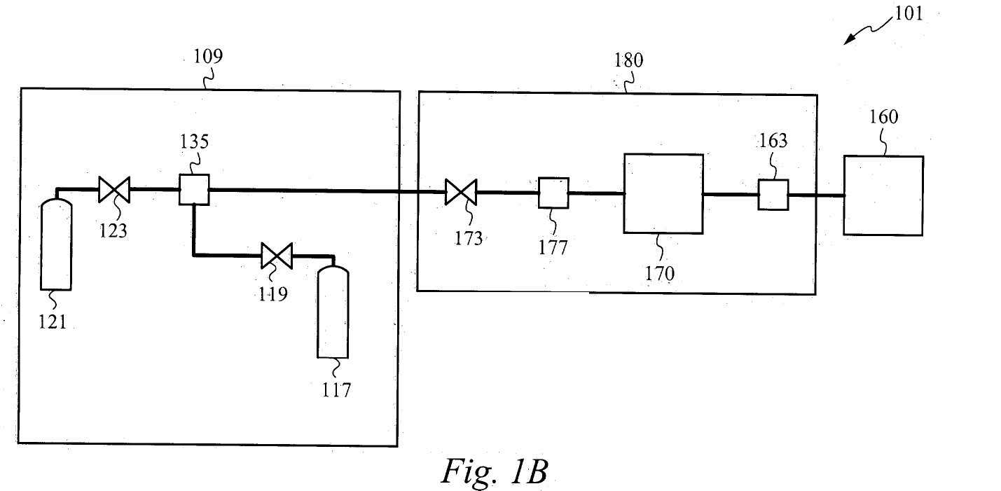

FIG. 1A is a schematic illustration of an apparatus for use in a system for supercritical processing of an object with a fluid, in accordance with embodiments of the present invention. As shown in FIG. 1A, in the preferred embodiment, an apparatus 100 for use in a system for supercritical processing of an object with a fluid includes a means for injecting 180 a processing chemistry into the system, including means for starting and means for stopping the means for injecting 180, and means 160 for substantially preventing fluid from re-entering the means for injecting 180. In certain embodiments of the invention, the means for injecting 180 comprises means for injecting at a predetermined pressure. Preferably, the predetermined pressure is in a range of approximately 2300 psi to approximately 3000 psi. In certain embodiments, the means 160 for substantially preventing fluid from re-entering the means for injecting 180 is operative when at least one of the means for stopping is active and the means for starting is active. In one embodiment, the means 160 for substantially preventing fluid from re-entering the means for injecting 180 comprises a back-pressure regulator.

In one embodiment of the invention, an apparatus 100 for use in a system for supercritical processing of an object with a fluid includes a fluid source 107 in fluid flow communication with the means for injecting 180. In certain embodiments, the means for injecting 180 includes a pump 170 coupled to a first backflow-prevention means 177 for substantially-preventing backflow of the processing chemistry. In one embodiment the first backflow-prevention means 177 is positioned between the fluid source 107 and the pump 170 In certain embodiments, the means for injecting 180 includes a second backflow-prevention means 163 for substantially preventing backflow of the processing chemistry. In one embodiment the second backflow-prevention means 163 is positioned between the pump 170 and the system. It should be appreciated that apparatus 100 can include either or both of the first backflow-prevention 177 and the second backflow-prevention means 163. In one embodiment, the first backflow-prevention means 177 and/or the second backflow-prevention means 163 comprise any number of check valves or the like. In certain embodiments, the means for starting and/or the means for stopping comprises a flow-control means 173. Any flow-control means 173 should be suitable for implementing the present invention, such as any number of valves, including ball valves, shovel valves, flapper valves, and valves having pneumatic actuators, electric actuators, hydraulic actuators, and/or micro-electric actuators. In one embodiment, the flow-control means 173 is positioned between the fluid source 107 and the pump 170.

FIG. 1B is a schematic illustration of an alternative embodiment of an apparatus for use in a system for supercritical processing of an object with a fluid shown in FIG. 1A. In FIG. 1B, like reference numbers are used when describing the same elements referred to in FIG. 1A. As FIG. 1B depicts, in one embodiment, an apparatus 101 includes a fluid supply means 109 for supplying the processing chemistry to the means for injecting 180. It should be appreciated that the fluid supply means 109 can include any combination of a fluid mixer 135, a first fluid source 121 in fluid communication with the mixer 135, a valve 123 for controlling a flow of a first fluid from the first fluid source to the mixer 135, a second fluid source 117 in fluid communication with the mixer 135, and a valve 119 for controlling a flow of a second fluid from the second fluid source to the mixer 135. In certain embodiments, either or both of the first fluid source 121 and the second fluid source 117 supply solvents, co-solvents, chemistries, and/or surfactants. Preferably, either or both of the first fluid source 121 and the second fluid source 117 supply gaseous, liquid, supercritical and/or near-supercritical carbon dioxide. It should be appreciated that solvents, co-solvents, chemistries, and/or surfactants can be contained in the carbon dioxide.

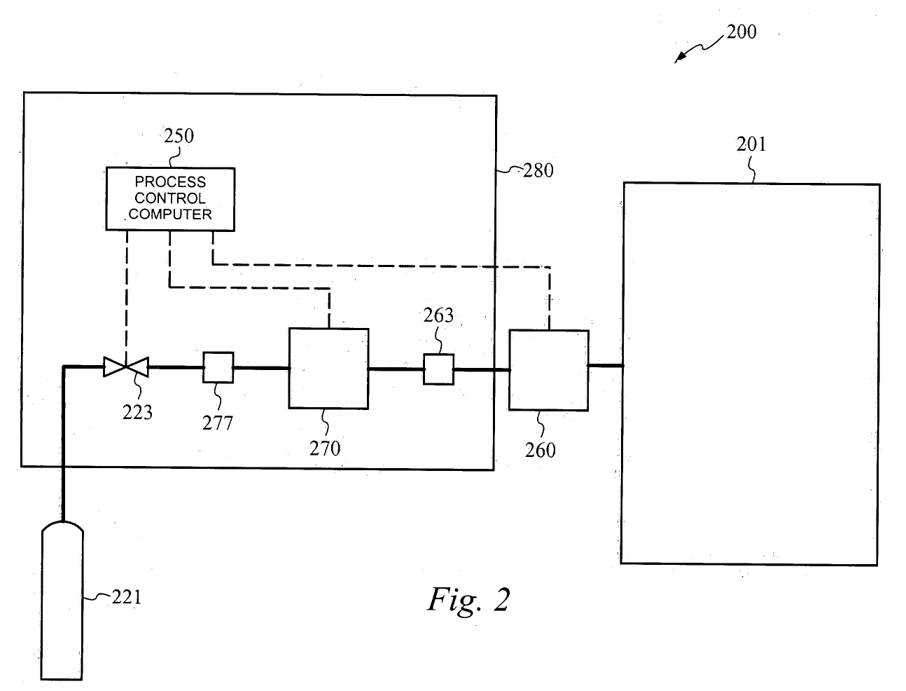

FIG. 2 is a schematic illustration of a system for supercritical processing 200 of an object with a fluid, in accordance with embodiments of the present invention. In certain embodiments, the object is a semiconductor wafer for forming integrated circuits. Preferably, the processing chemistry is gaseous, liquid, supercritical and/or near-supercritical carbon dioxide. It should be appreciated that chemistries, solvents, co-solvents, surfactants, or combination thereof can be contained in the carbon dioxide. In accordance with one embodiment, the system 200 includes a high-pressure process chamber 201. The details concerning one example of a processing chamber are disclosed in co-owned and co-pending U.S. patent application Ser. No. 09/912,844, entitled “HIGH PRESSURE PROCESSING CHAMBER FOR SEMICONDUCTOR SUBSTRATE,” filed Jul. 24, 2001, Ser. No. 09/970,309, entitled “HIGH PRESSURE PROCESSING CHAMBER FOR MULTIPLE SEMICONDUCTOR SUBSTRATES,” filed Oct. 3, 2001, Ser. No. 10/121,791, entitled “HIGH PRESSURE PROCESSING CHAMBER FOR SEMICONDUCTOR SUBSTRATE INCLUDING FLOW ENHANCING FEATURES,” filed Apr. 10, 2002, and Ser. No. 10/364,284, entitled “HIGH-PRESSURE PROCESSING CHAMBER FOR A SEMICONDUCTOR WAFER,” filed Feb. 10, 2003, the contents of which are incorporated herein by reference.

As shown in FIG. 2, in one embodiment, the system 200 for supercritical processing of an object with a fluid includes a means for injecting 280 a processing chemistry into the high-pressure process chamber 201 including means for starting and means for stopping the means for injecting 280. Preferably, the system 200 includes means 260 for substantially preventing fluid from re-entering the means for injecting 280, wherein the means 260 is coupled between the means for injecting 280 and the process chamber 201. In one embodiment, the means for injecting 280 comprises means for injecting at a predetermined pressure. Preferably, the predetermined pressure is in a range of approximately 2300 psi to approximately 3000 psi. In certain embodiments, the means for injecting 280 comprises a pump 270, a first backflow-prevention means 277 for substantially preventing backflow of the processing chemistry, and/or a second backflow-prevention means 263 for substantially preventing backflow of the processing chemistry. In one embodiment the first backflow-prevention means 277 is positioned between the fluid source 221 and the pump 270. In one embodiment the second backflow-prevention means 263 is positioned between the pump 270 and the system. In one embodiment, the first backflow-prevention means 277 and/or the second backflow-prevention means 263 comprises any number of check valves or the like.

In certain embodiments, the means for starting and/or the means for stopping comprises a flow-control means 223. Flow-control means 223 suitable for use with the present invention include various types of valves, such as ball valves, shovel valves, flapper valves, and valves having pneumatic actuators, electric actuators, hydraulic actuators, and/or micro-electric actuators. In certain embodiments, the means 260 for substantially preventing fluid from re-entering the means for injecting 280 is operative when at least one of or both the means for stopping is active and the means for starting is active. In one embodiment, the means 260 for substantially preventing fluid from re-entering the means for injecting 280 comprises a back-pressure regulator.

In one embodiment, a system 200 for supercritical processing of an object with a fluid includes means for circulating a fluid, wherein the means for circulating a fluid is coupled to the high-pressure process chamber 201. In certain embodiments, a process control computer 250 is coupled for controlling any number of valves, pneumatic actuators, electric actuators, hydraulic actuators, micro-electric actuators, pumps, and/or a back-pressure regulator, as shown by the dotted lines in FIG. 2.

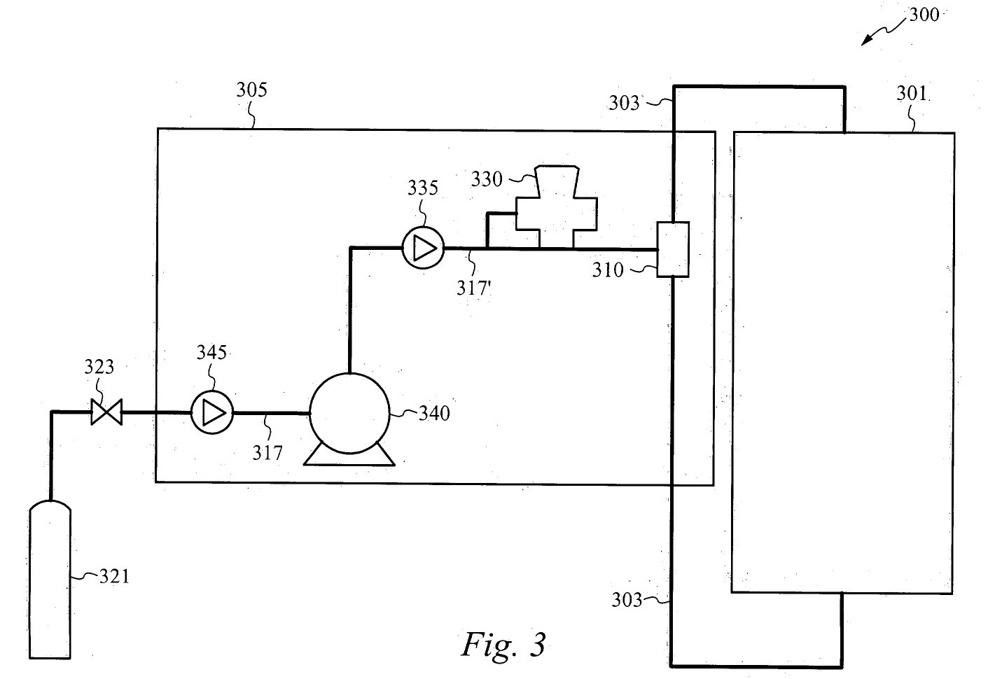

FIG. 3 is a schematic illustration of a supercritical processing system 300 for processing a semiconductor wafer with a fluid, in accordance with embodiments of the present invention. As FIG. 3 depicts, in one embodiment of the invention, a supercritical processing system 300 for processing a semiconductor wafer with a fluid includes a circulation loop 303 coupled to a high-pressure processing chamber 301. In one embodiment, the supercritical processing system 300 includes an inlet line 305 for introducing the fluid into the circulation loop 303. In certain embodiments, the inlet line 300 includes an inlet port 310 in the circulation loop 303 and a back-pressure regulator 330 coupled to the inlet port 310. In one embodiment of the invention, the inlet line 300 includes a pump 340 for compressing the fluid to form a pressurized fluid, a first line 317′ for transferring the pressurized fluid from the pump 340 to the back-pressure regulator 330 and a second line 317 for transferring a quantity of the fluid from the fluid source 350 to the pump 340. In one embodiment, the first line 317′ is configured to maintain a uni-directional flow of the pressurized fluid from the pump towards the back-pressure regulator. In one embodiment, the second line 317 is configured to maintain a uni-directional flow of the fluid from the fluid source 350 to the pump 340.

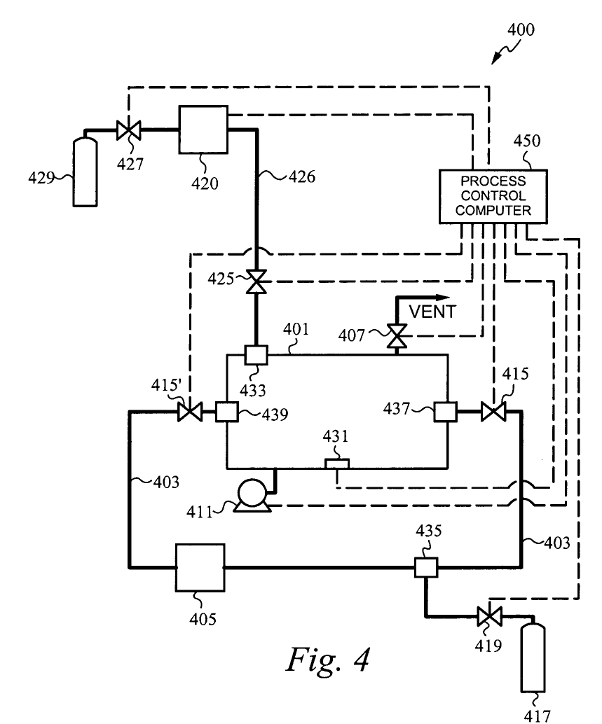

FIG. 4 is a schematic illustration of a system 400 for supercritical processing of an object with a fluid, in accordance with embodiments of the present invention. FIG. 4 shows that system 400 includes a fluid source 429 that is coupled to an inlet line 426 through a source valve 427 which can be selectively opened and closed to start and stop the flow of a fluid from the fluid source 429 to the inlet line 426. The inlet line 426 is preferably equipped with one or more back-flow valves, pumps and/or heaters 420 for generating and/or maintaining a process stream. As used herein, “process stream” comprises fluids, fluid mixtures, including supercritical fluids, cleaning chemistry and/or rinsing chemistry. The inlet line 426 also preferably has an inline valve 425 that is configured to open and close to allow or prevent a process stream from flowing into the processing chamber 401 through a means for introducing the process stream 433, such as a needle valve, orifice, valve, and/or a pump. The processing chamber 401 is preferably equipped with one or more pressure valves 407 for exhausting the processing chamber 401 and/or for regulating the pressure within the processing chamber 401. In accordance with the embodiments of the invention, the processing chamber 401 is coupled with a pump 411 and/or a vacuum (not shown) for pressurizing and/or evacuating the processing chamber 401. In certain embodiments, the processing chamber 401 is coupled with a heater 431.

In preferred embodiments, a means is provided for recirculating a process stream within the processing chamber 401. The means for recirculating can include an outlet port 437 which is coupled to a recirculation loop 403 which is coupled to any number of back-flow valves, check valves, recirculation pumps and/or heaters 405 which in turn is coupled to an inlet port 439 for reintroducing the process stream into the processing chamber 401. The recirculation loop 403 is preferably equipped with one or more valves 415 and 415′ for regulating the flow of process streams through the recirculation loop 403 and through the processing chamber 401. In one embodiment, the recirculation loop 403 includes an injection port 435 for introducing chemistry such as a cleaning chemistry (e.g., solvents, co-solvents and/or surfactants) or a rinsing chemistry (e.g., water and a solvent such as ethanol, acetone or IPA) from a chemistry source 417 into the recirculation loop 403.

According to certain preferred embodiments, the means for introducing a process stream 433 into the processing chamber 401 operates while maintaining a constant pressure in the processing chamber 401. In one embodiment, the apparatus includes a back-pressure regulator for maintaining a constant pressure in the processing chamber. Preferably, an apparatus in accordance with the invention includes means for performing a series of decompression cycles, such as a pump and a vent. Preferably, an apparatus in accordance with the invention includes a process control computer 450 coupled for controlling any number of valves 407, 415, 415′, 419, 423, 425, and 427, pumps 411, heaters 431, or other devices (not shown). The control signals are shown coupled with dotted lines in FIG. 4.

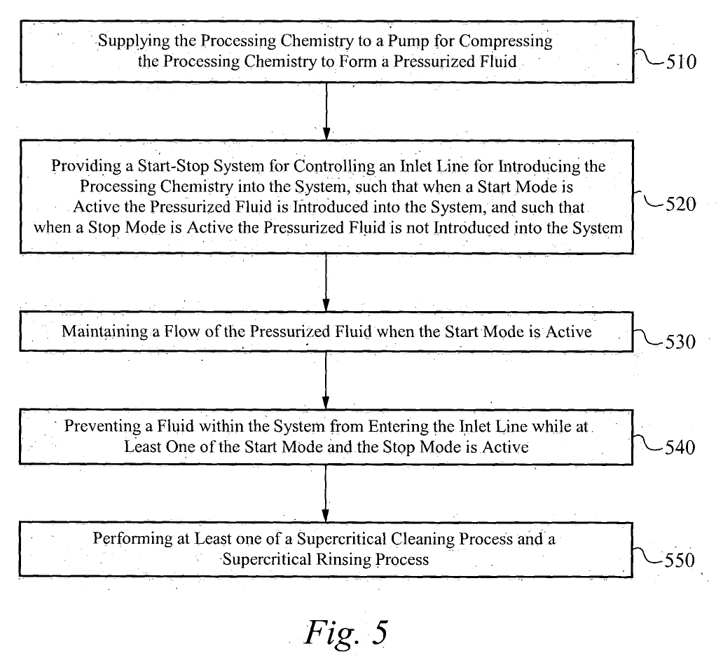

FIG. 5 is a flow chart showing a method of regulating a flow of a processing chemistry into a system for supercritical processing of an object with a fluid, in accordance with embodiments of the present invention. In certain embodiments, the object is a semiconductor wafer for forming integrated circuits. Preferably, the processing chemistry is gaseous, liquid, supercritical and/or near-supercritical carbon dioxide. It should be appreciated that solvents, co-solvents, and/or surfactants can be contained in the carbon dioxide.

In step 510, the processing chemistry is supplied to a pump for compressing the processing chemistry to form a pressurized fluid. In step 520, a start-stop system is provided for controlling an inlet line for introducing the processing chemistry into the system, such that when a start mode is active the pressurized fluid is introduced into the system, and such that when a stop mode is active the pressurized fluid is not introduced into the system. In step 530, a flow of the pressurized fluid is maintained when the start mode is active. In one embodiment, maintaining a flow of the pressurized fluid in step 530 comprises operating the pump such that a predetermined quantity of the processing chemistry is introduced into the system. In one embodiment, the predetermined quantity of the processing chemistry is introduced into the system at a predetermined pressure. Preferably, the predetermined pressure is in a range of approximately 2300 psi to approximately 3000 psi. In step 540, a fluid within the system is prevented from entering the inlet line while at least one of the start mode and the stop mode is active. In one embodiment, preventing a fluid within the system from entering the inlet line in step 540 comprises providing a back-pressure regulator. In an optional step 550, at least one of a supercritical cleaning process and a supercritical rinsing process is performed.

While the processes and apparatus of this invention have been described in detail for the purpose of illustration, the inventive processes and apparatus are not to be construed as limited thereby. It will be readily apparent to those of reasonable skill in the art that various modifications to the foregoing preferred embodiments can be made without departing from the spirit and scope of the invention as defined by the appended claims.

1. An apparatus for use in a system for supercritical processing of an object with a fluid, comprising:
means for injecting a processing chemistry into the system, including means for starting and means for stopping the means for injecting; and
means for substantially preventing fluid from re-entering the means for injecting.

2. The apparatus of claim 1 wherein the means for injecting comprises means for injecting at a predetermined pressure.

3. The apparatus of claim 2 wherein the predetermined pressure is in a range of approximately 2300 psi to approximately 3000 psi.

4. The apparatus of claim 2 wherein the means for injecting further comprises at least one of a pump, a first backflow-prevention means for substantially preventing backflow of the processing chemistry, and a second backflow-prevention means for substantially preventing backflow of the processing chemistry.

5. The apparatus of claim 4 wherein at least one of the first backflow-prevention means and the second backflow-prevention means comprises at least one check valve.

6. The apparatus of claim 1 wherein at least one of the means for starting and the means for stopping comprises a flow-control means.

7. The apparatus of claim 6 wherein the flow-control means comprises at least one of a valve, a pneumatic actuator, an electric actuator, a hydraulic actuator, and a micro-electric actuator.

8. The apparatus of claim 1 wherein the means for substantially preventing fluid from re-entering the means for injecting is operative when at least one of the means for stopping is active and the means for starting is active.

9. The apparatus of claim 8 wherein the means for substantially preventing fluid from re-entering the means for injecting comprises a back-pressure regulator.

10. The apparatus of claim 1 wherein the object is a semiconductor wafer for forming integrated circuits.

11. The apparatus of claim 1 further comprising a fluid source in fluid flow communication with the means for injecting.

12. The apparatus of claim 1 further comprising a fluid supply means for supplying the processing chemistry to the means for injecting.

13. The apparatus of claim 12 wherein the processing chemistry is at least one of gaseous, liquid, supercritical and near-supercritical carbon dioxide.

14. The apparatus of claim 13 wherein at least one of solvents, co-solvents and surfactants are contained in the carbon dioxide.

15. The apparatus of claim 12 wherein the fluid supply means comprises at least one of a fluid mixer, a first fluid source, a valve for controlling a flow of a first fluid from the first fluid source, a second fluid source, and a valve for controlling a flow of a second fluid from the second fluid source.

16. A system for supercritical processing of an object with a fluid, comprising:
a high-pressure process chamber;
means for injecting a processing chemistry into the high-pressure process chamber including means for starting and means for stopping the means for injecting; and
means for substantially preventing fluid from re-entering the means for injecting.

17. The system of claim 16 wherein the means for injecting comprises means for injecting at a predetermined pressure.

18. The system of claim 17 wherein the predetermined pressure is in a range of approximately 2300 psi to approximately 3000 psi.

19. The system of claim 16 wherein the means for injecting includes at least one of a pump, a first backflow-prevention means for substantially preventing backflow of the processing chemistry, and a second backflow-prevention means for substantially preventing backflow of the processing chemistry.

20. The system of claim 19 wherein at least one of the first backflow-prevention means and the second backflow-prevention means comprises at least one check valve.

21. The system of claim 16 wherein at least one of the means for starting and means for stopping comprises a flow-control means.

22. The system of claim 21 wherein the flow-control means comprises at least one of a valve, a pneumatic actuator, an electric actuator, a hydraulic actuator, and a micro-electric actuator.

23. The system of claim 16 wherein the means for substantially preventing fluid from re-entering the means for injecting is operative when at least one of the means for stopping is active and the means for starting is active.

24. The system of claim 23 wherein the means for substantially preventing fluid from re-entering the means for injecting comprises a back-pressure regulator.

25. The system of claim 16 further comprising means for circulating a fluid, wherein the means for circulating a fluid is coupled to the high-pressure process chamber.

26. The system of claim 16 further comprising a process control computer coupled for controlling at least one of a valve, a pneumatic actuator, an electric actuator, a hydraulic actuator, a micro-electric actuator, a pump, and a back-pressure regulator.

27. The system of claim 16 wherein the object is a semiconductor wafer for forming integrated circuits.

28. The system of claim 16 wherein the processing chemistry is at least one of gaseous, liquid, supercritical and near-supercritical carbon dioxide.

29. The system of claim 28 wherein at least one of solvents, co-solvents and surfactants are contained in the carbon dioxide.

30. A supercritical processing system for processing a semiconductor wafer with a fluid, the fluid being from a fluid source, the system comprising:
a. a circulation loop coupled to a high-pressure processing chamber; and
b. an inlet line for introducing the fluid into the circulation loop, the inlet line including:
i. an inlet port in the circulation loop;
ii. a back-pressure regulator coupled to the inlet port;
iii. a pump for compressing the fluid to form a pressurized fluid;
iv. a first line for transferring the pressurized fluid from the pump to the back-pressure regulator, the first line configured to maintain a uni-directional flow of the pressurized fluid from the pump towards the back-pressure regulator; and
v. a second line for transferring a quantity of the fluid from the fluid source to the pump, the second line configured to maintain a uni-directional flow of the fluid from the fluid source to the pump.

31. A method of regulating a flow of a processing chemistry into a system for supercritical processing of an object with a fluid, comprising the steps of:
a. supplying the processing chemistry to a pump for compressing the processing chemistry to form a pressurized fluid;
b. providing a start-stop system for controlling an inlet line for introducing the processing chemistry into the system, such that when a start mode is active the pressurized fluid is introduced into the system, and such that when a stop mode is active the pressurized fluid is not introduced into the system;
c. maintaining a flow of the pressurized fluid when the start mode is active; and
d. preventing a fluid within the system from entering the inlet line while at least one of the start mode and the stop mode is active.

32. The method of claim 31 wherein the step of maintaining a flow of the pressurized fluid comprises operating the pump such that a predetermined quantity of the processing chemistry is introduced into the system.

33. The method of claim 32 wherein the predetermined quantity of the processing chemistry is introduced into the system at a predetermined pressure.

34. The method of claim 33 wherein the predetermined pressure is in a range of approximately 2300 psi to approximately 3000 psi.

35. The method of claim 31 wherein the step of preventing a fluid within the system from entering the inlet line comprises providing a back-pressure regulator.

36. The method of claim 31 wherein the object is a semiconductor wafer for forming integrated circuits.

37. The method claim 31 wherein the processing chemistry is at least one of gaseous, liquid, supercritical and near-supercritical carbon dioxide.

38. The method claim 33 wherein at least one of solvents, co-solvents and surfactants are contained in the carbon dioxide.

39. The method claim 31 further comprising performing at least one of a supercritical cleaning process and a supercritical rinsing process.
